(19) United States
(12) Patent Application Publication
(10) Pub. No.: US 2011/0204777 A1
(43) Pub. Date: Aug. 25, 2011

(54) SETTABLE LIGHT BULBS

(75) Inventor: Ronald J. Lenk, Woodstock, GA (US)

(73) Assignee: Switch Bulb Company, Inc., San Jose, CA (US)

(21) Appl. No.: 13/059,396

(22) PCT Filed: Aug. 14, 2009
(86) PCT No.: PCT/US09/04661

§ 371 Date: May 16, 2011

Related U.S. Application Data
(60) Provisional application No. 61/089,628, filed on Aug. 18, 2008.

(51) Int. Cl. H05B 37/02; H01J 7/44; H01K 1/62

(52) U.S. Cl. 315/32

(57) ABSTRACT

A settable light bulb whose brightness can be set by the user, and more particularly, to the use of a switch or a slide built in to the bulb itself to control the brightness in either discrete or continuous increments.

### FIELD OF THE INVENTION

The present invention relates to light bulbs whose brightness can be set by the user, and more particularly, to the use of a switch or a slide, which is built in to the bulb to control the brightness in either discrete and/or continuous increments.

### BACKGROUND OF THE INVENTION

A light bulb typically comes with brightness preset by the factory. The brightness is typically proportional to the current through the light-emitting element or elements. The user of the bulb screws the bulb into an appropriately rated socket, and then the bulb may be set to be either on or off with a wall-mounted switch, with no intermediate choices. Three common technologies for the light bulb are incandescent, fluorescent and LED (light emitting diode). The most common is still the incandescent bulb, formed by surrounding a very hot filament in a partial vacuum with a glass shell. The fluorescent bulb is formed by surrounding a plasma column with a glass shell containing a phosphor, the phosphor serving to convert the ultraviolet radiation emitted by the plasma into visible light. Fluorescent bulbs which are designed to screw into conventional sockets are generically referred to as compact fluorescent lamps (or CFLs). Meanwhile, the LED bulb is formed by surrounding the LEDs with air or a fluid, gel or plastic, and encasing the LED inside a plastic shell.

In some cases, bulb brightness may be continuously adjusted if the wall-mounted control unit includes a dimmer or dimmer switch. This works well for incandescent and LED light bulbs, and to some extent for fluorescent bulbs, if they have been specially designed to work with this type of control unit. Another method of controlling bulb brightness is the use of a 3-way socket, which permits discrete adjustment. Again, this works well with LED light bulbs and with 3-way incandescent bulbs, and with specially designed fluorescent bulbs.

However, both dimmers and 3-ways require a specially-designed control unit. Most control units are simply on/off switches, and do not permit dimming or brightness-setting, even with bulbs that are designed for it.

In many circumstances, it would be desirable to have the ability to control light bulb brightness without the presence of a specially designed control unit. A settable bulb would permit the dimming or selection of light output in the absence of a dimmer or 3-way controller. Another use would be when only a single type of bulb was available, but different brightness was desired in different locations. Accordingly, it would be desirable to a have a settable light bulb, which would permit multiple light level settings in a socket not configured for 3-way operation, and alleviate the problem of stocking multiple types of bulbs.

### SUMMARY OF THE INVENTION

This invention has the object of developing an apparatus with settable light output such that the above-described primary problem is effectively solved. In accordance with an embodiment, the apparatus with settable light output provides a light bulb whose light output may be either continuously or discretely set by the user, without requiring any special external control circuitry. The apparatus includes a light bulb, preferentially an LED light bulb, and includes either a slider control or a switch with at least two positions. The slider or switch controls either directly or indirectly, the current flowing in the light-emitting element or elements, thus controlling the brightness of the bulb.

In accordance with one embodiment, a slider with a continuous range which is embedded in the body of the light bulb sets the current flowing in the light-emitting element or elements. In accordance with an embodiment, the slider can be a potentiometer feeding a signal proportional to the current back to a control circuit. The potentiometer can have a resistor in series, which sets the maximum current.

In accordance with another embodiment, a switch with at least two discrete settings which is embedded in the body of the light bulb sets the current flowing in the light-emitting element or elements. The switch can select one of a number of discrete resistors feeding a signal proportional to the current back to a control circuit.

In accordance with another embodiment, the slider or switch may control the frequency of oscillation of a circuit controlling a compact fluorescent lamp (or CFL). Control of the frequency controls the current flowing through the CFL, and thus the brightness of the CFL.

In accordance with another embodiment, the switch controls which of at least two filaments is powered in an incandescent bulb. One setting of the switch turns on a first filament, a second setting turns on a second filament, and a third setting turns on both the first and the second filaments.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional view of a light bulb with a slider or switch embedded in its shell.

FIG. 2 is a schematic of a circuit that utilizes a slider in the form of a potentiometer to continuously adjust the current, and thus the light output in an LED light bulb.

FIG. 3 is a schematic of a circuit that utilizes a switch to set the current, and thus the light output in an LED light bulb to three predefined levels.

FIG. 4 is a block diagram of a circuit that may utilize either a slider or switch to control the current through, and the brightness of a compact fluorescent lamp or CFL.

FIG. 5 is a cross-section view of a compact fluorescent lamp or CFL with a slider or switch embedded in the base of the bulb.

FIG. 6 is a cross-sectional view of a light bulb that utilizes a switch to control the number of filaments powered in an incandescent bulb.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

According to the design characteristics, a detailed description of the current practice and preferred embodiments is given below.

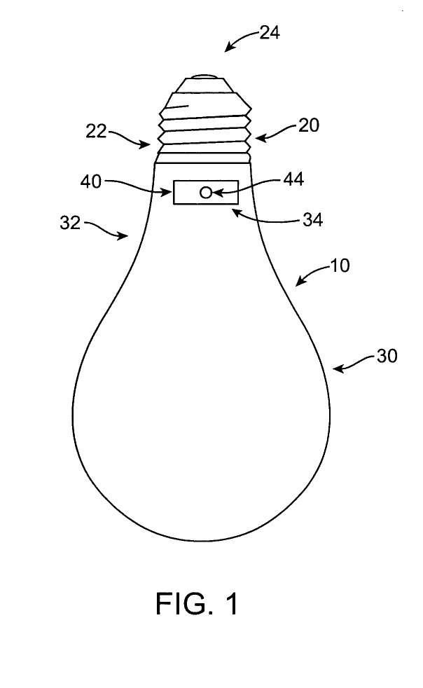

FIG. 1 is a cross-sectional view of a light bulb 10 with a slider or switch 40 embedded in its shell 30. As shown in FIG. 1, the light bulb 10 includes a screw-in base 20, a plastic shell 30, and a control mechanism 34 in the form of a slider or switch 40. The screw-in base 20 includes a series of screw threads 22 and a base pin 24. The screw-in base 20 is configured to fit within and make electrical contact with a standard electrical socket. The electrical socket is preferably dimensioned to receive an incandescent or other standard light bulb as known in the art. However, it can be appreciated that the screw-in base 20 can be modified to fit within any electrical socket which is configured to receive a light bulb, such as a bayonet style base. The screw-in base 20 makes electrical contact with the AC power in a socket through its screw threads 22 and its base pin 24. The slider or switch 40 is embedded within the neck 32 of the shell 30, although it can also be in some other portion of the shell 30. In accordance with an alternative embodiment, the slider or switch 40 can be recessed within the neck 32 or raised above it, and preferably forms a seamless whole with said neck 32. The slider or switch 40 has a control 44. The control 44 is used to set the light output of the light bulb 10 in either a continuous range or a discrete range.

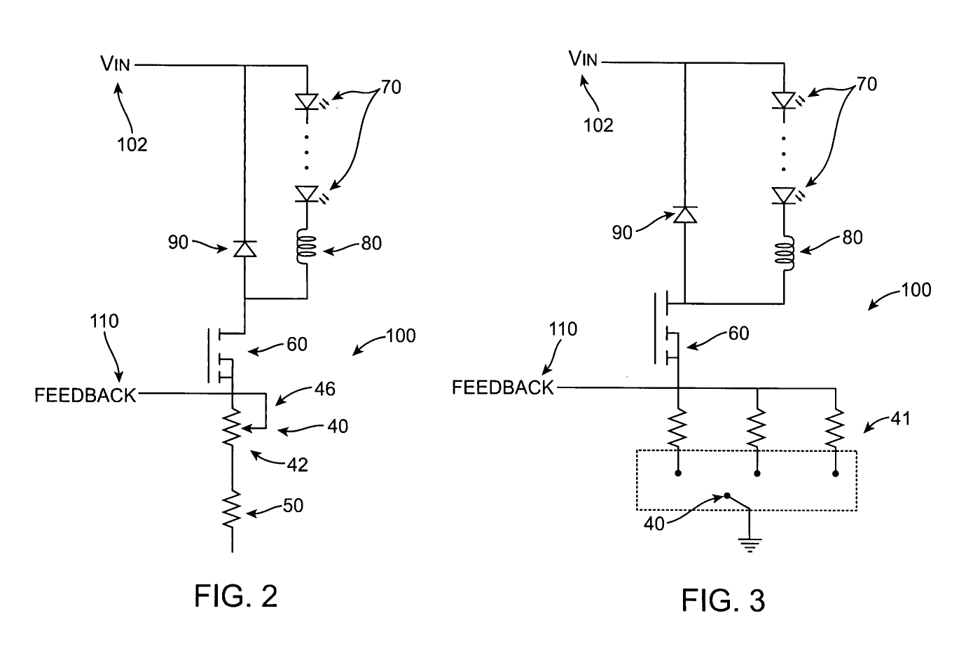

FIG. 2 is a schematic of a circuit 100 that utilizes a slider 40 in the form of a potentiometer 42 to continuously adjust the current and thus the light output in an LED light bulb. In this schematic, input power 102 is supplied to the circuit 100 from a DC or AC rectified source, not shown. The input power 102 is fed to a string of at least one LED 70 in series, and this in turn has its current controlled by an inductor 80. The actual current in said inductor 80 and said at least one LED 70 is set by the duty cycle of a switching transistor 60. Increasing the duty cycle of said transistor 60 increases the current, while decreasing it decreases the current. During the off-time of said transistor 60, the current in said inductor 80 and said at least one LED 70 is fed back to the input power 102 by a diode 90. The current in transistor 60, which is equal to the current in the inductor 80 and the at least one LED 70 during said transistor's 60 on-time, is measured by the potentiometer 42 and series limiting resistor 50. The voltage 110 measured across said potentiometer 42 and the series limiting resistor 50 is used as feedback control to a regulator or control circuit, not shown, which controls the duty cycle of the transistor 60. In accordance with an embodiment, the resistance of potentiometer 42 can be altered by setting a wiper 46, which alters the voltage 110. By altering the voltage 110, the current through the at least one LED 70 is altered. In accordance with an exemplary embodiment, the potentiometer 42 sends a feedback signal to the regulator or control circuit, and wherein the feedback signal and corresponding voltage 110 is proportional to the current of the at least one LED 70.

FIG. 3 is a schematic of a circuit 100 that utilizes a switch 40 to set the current and thus the light output in an LED light bulb to three predefined levels. In this schematic, input power 102 is supplied to the circuit from a DC or AC rectified source, not shown. The input power 102 is fed to a string of at least one LED 70 in series, and this in turn has its current controlled by an inductor 80. The actual current in said inductor 80 and said at least one LED 70 is set by the duty cycle of a switching transistor 60. Increasing the duty cycle of said transistor 60 increases the current, while decreasing the duty cycle of the transistor 60 decreases the current. During the off-time of said transistor 60, the current in said inductor 80 and said at least one LED 70 is fed back to the input power 102 by diode 90. The current in the transistor 60, which is equal to the current in the inductor 80 and the at least one LED 70 during the transistor's 60 on-time, is measured by one of the paralleled resistors 41. The voltage 110 measured across one of the resistors 41 is used as feedback control to a regulator or control circuit, not shown, which controls the duty cycle of the transistor 60. In accordance with an embodiment, selecting a different resistor from the paralleled resistors 41 by setting the switch 40 alters the voltage 110 and a corresponding feedback signal. By altering the feedback signal and the corresponding voltage 110, the current through the at least one LED 70 is altered. In accordance with an exemplary embodiment, the switch 40 sends a feedback signal to the regulator or control circuit, and wherein the feedback signal and corresponding voltage 110 is proportional to the current of the at least one LED 70. It can be appreciated that the circuit 100 can include more or less than three settings. It can be appreciated that in accordance with a preferred embodiment, the slider and/or switch 40 is preferably electrically isolated from other circuitry in the bulb 10.

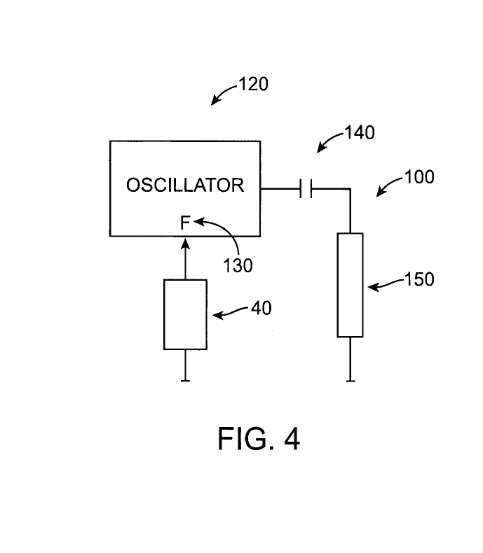

FIG. 4 is a block diagram of a circuit 100 that utilizes either a slider or switch 40 to control the current through, and thus the brightness of a compact fluorescent lamp (CFL) 150. The current through the CFL 150 is controlled by the value of the blocking capacitor 140 and the frequency of a power oscillator 120. If the frequency of said oscillator 120 is controlled to be higher, the impedance of said capacitor 140 will be lower, and so the current through the CFL 150 will be higher; and similarly, if the frequency of said oscillator 120 is lower, the impedance of said capacitor 140 will be higher, and so the current through the CFL 150 will be lower. The frequency of the oscillator 120 is set by a control 130. In turn, the signal to control 130 is set from the slider or switch 40. The slider or switch 40 thus sets the current through the CFL 150.

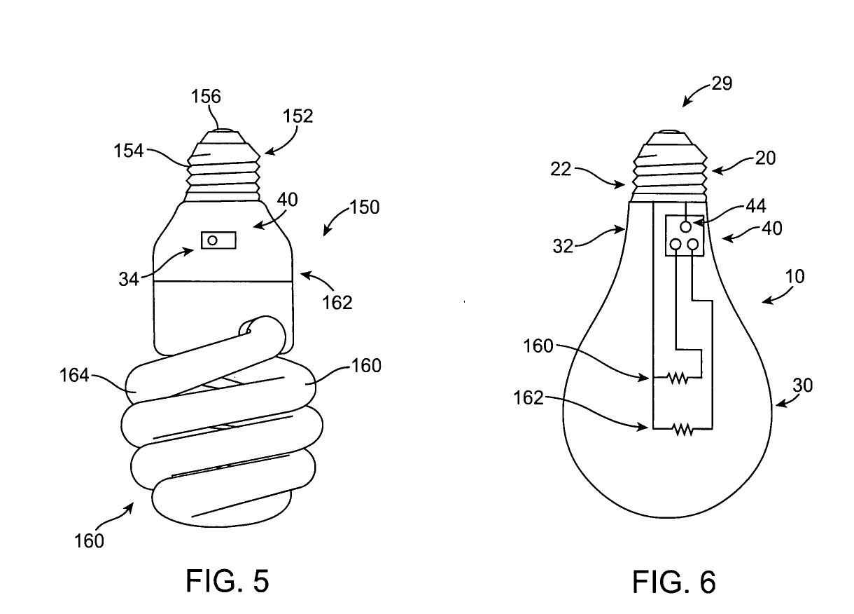

FIG. 5 is a cross-section view of a compact fluorescent lamp or CFL 150 with a control mechanism 34 in the form slider or switch 40 embedded in a base portion 162 of the CFL bulb 150. The CFL bulb 150 includes a plasma column 160 in the form of a tubular element 164, which fluoresces when properly excited. For example, the tubular element 164 can be partially evacuated and filled with a gas or material. In accordance with an exemplary embodiment, the settable fluorescent light bulb or CFL 150 includes a fluorescent tube (or tubular element) 164 and a control mechanism 34 which is part of the bulb 150. The control mechanism 34 sets a brightness of the bulb 150 by controlling the current through the plasma column 160. The control mechanism 34 can be a slider or switch 40. In accordance with an embodiment, the slider 40 is a potentiometer 42 (FIG. 2) that sets a frequency of oscillation of a ballast running the fluorescent bulb 150. Alternatively, the switch 40 controls at least one resistor that sets the frequency of oscillation of a ballast running the fluorescent bulb 150. It can be appreciated that in accordance with a preferred embodiment, the slider and/or switch 40 is preferably electrically isolated from other circuitry in the bulb 150.

As shown in FIG. 5, the bulb 150 also includes a screw-in base 152, which includes a series of screw threads 154 and a base pin 156. The screw-in base 152 is configured to fit within and make electrical contact with a standard electrical socket. The electrical socket is preferably dimensioned to receive an incandescent or other standard light bulb as known in the art. However, it can be appreciated that the screw-in base 152 can be modified to fit within any electrical socket which is configured to receive a light bulb, such as a bayonet style base. The screw-in base 152 makes electrical contact with the AC power in a socket through its screw threads 154 and its base pin 156.

FIG. 6 is a cross-sectional view of a bulb 10 that utilizes a switch to control the number of filaments powered in an incandescent bulb 10. As shown in FIG. 6, the light bulb 10 includes a screw-in base 20, a plastic shell 30, and a slider or switch 40. The screw-in base 20 includes a series of screw threads 22 and a base pin 24. The screw-in base 20 is configured to fit within and make electrical contact with a standard electrical socket. The electrical socket is preferably dimensioned to receive an incandescent or other standard light bulb as known in the art. However, it can be appreciated that the screw-in base 20 can be modified to fit within any electrical socket which is configured to receive a light bulb, such as a bayonet style base. The screw-in base 20 makes electrical contact with the AC power in a socket through its screw threads 22 and its base pin 24.

In accordance with an embodiment, the switch 40 is embedded within the neck 32 of the shell 30, although it may also be in some other portion of the shell. Alternatively, in accordance with another embodiment, the switch 40 can be recessed within the neck 32 or raised above the neck 32, and preferably forms a seamless whole with said neck 32. In accordance with an embodiment, the switch 40 has a control 44, with the control 44 having two states. In the first of the two states, AC power is applied to a first filament 160. In the second of the two states, AC power is applied to a second filament 162. Thus, the control 44 sets or determines which of the two filaments 160 or 162 are energized, and the brightness of the incandescent bulb 10. In accordance with a further embodiment, it can be appreciated that arrangements with more than two settings can also be implemented using one or more controls 44. In accordance with an exemplary embodiment, the switch 40 is electrically isolated from other circuitry in said bulb. In accordance with an exemplary embodiment, the switch 40 preferably has three settings, (i.e., a 3-way bulb), with settings corresponding to the power being applied to the first filament 160 (first setting), the second filament 162 (second setting), and both the first and the second filaments together (third setting).

It will be apparent to those skilled in the art that various modifications and variation can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A settable LED light bulb comprising:
at least one LED;
an outer shell;
a base adapted to fit within an electrical socket; and
a control mechanism which is part of the bulb, said control mechanism setting a brightness of the bulb by controlling the current of the at least one LED.

2. A settable LED light bulb as set forth in claim 1, wherein the control mechanism is a slider.

3. A settable LED light bulb as set forth in claim 2, wherein the slider is a potentiometer that sends a feedback signal to a control circuit, and wherein the signal is proportional to the current of the at least one LED.

4. A settable LED light bulb as set forth in claim 2, wherein the slider is electrically isolated from other circuitry in said bulb.

5. A settable LED light bulb as set forth in claim 1, wherein the control mechanism is a switch.

6. A settable LED light bulb as set forth in claim 5, wherein the switch controls at least one resistor that sends a feedback signal to a control circuit, and wherein the feedback signal is proportional to the at least one LED current.

7. A settable LED light bulb as set forth in claim 5, wherein the switch is electrically isolated from the other circuitry in said bulb.

8. A settable fluorescent light bulb comprising:
a fluorescent light bulb; and
a control mechanism which is part of the bulb, said control mechanism setting a brightness of the bulb by controlling current through a plasma column.

9. A settable fluorescent light bulb as set forth in claim 8, wherein the control mechanism is a slider.

10. A settable fluorescent light bulb as set forth in claim 9, wherein the slider is a potentiometer that sets a frequency of oscillation of a ballast running the fluorescent bulb.

11. A settable fluorescent light bulb as set forth in claim 9, wherein the slider is electrically isolated from other circuitry in said bulb.

12. A settable fluorescent light bulb as set forth in claim 8, wherein the control mechanism is a switch.

13. A settable fluorescent light bulb as set forth in claim 12, wherein the switch controls at least one resistor that sets the frequency of oscillation of a ballast running the fluorescent bulb.

14. A settable fluorescent light bulb as set forth in claim 12, wherein the switch is electrically isolated from other circuitry in said bulb.

15. A settable incandescent light bulb comprising:
an incandescent light bulb; and
a switch which is part of the bulb, said switch setting a brightness of the bulb by controlling which of at least two filaments is powered.

16. A settable incandescent light bulb as set forth in claim 15, wherein the switch is electrically isolated from other circuitry in said bulb.
